(19) United States
(12) Patent Application Publication
(10) Pub. No.: US 2017/0097854 A1
(43) Pub. Date: Apr. 6, 2017

(54) TASK PLACEMENT FOR RELATED TASKS IN A CLUSTER BASED MULTI-CORE SYSTEM

(71) Applicant: Qualcomm Innovation Center, Inc., San Diego, CA (US)

(72) Inventors: Premal Shah, San Diego, CA (US); Omprakash Dhyade, San Diego, CA (US); Srivatsa Vaddagiri, Bangalore (IN); Stephen Muckle, San Diego, CA (US)

(21) Appl. No.: 15/220,257

(22) Filed: Jul. 26, 2016

Related U.S. Application Data
(60) Provisional application No. 62/235,788, filed on Oct. 1, 2015.

(51) Int. Cl. G06F 9/50; G06F 9/48

(52) U.S. Cl. CPC G06F 9/5083; G06F 9/4881

(57) ABSTRACT

An example apparatus and method are disclosed for scheduling a plurality of threads for execution on a cluster of a plurality of clusters. The method includes determining that a first thread is dependent on a second thread. The first and second threads process a workload for a common frame. The method also includes selecting a cluster of a plurality of clusters. The method further includes scheduling the first and second threads for execution on the selected cluster.

### CLAIM OF PRIORITY UNDER 35 U.S.C. §119

The present Application for Patent claims priority to Provisional Application No. 62/235,788 entitled “Optimal Task Placement for Related Tasks in a Cluster Based Multi-core System” filed Oct. 1, 2015, and assigned to the assignee hereof and hereby expressly incorporated by reference herein.

### FIELD OF DISCLOSURE

The present disclosure generally relates to processing tasks, and more particularly to processing tasks in a cluster based multi-core system.

### BACKGROUND

Computing devices including devices such as smartphones, tablet computers, gaming devices, and laptop computers are now ubiquitous. These computing devices are now capable of running a variety of applications (also referred to as “apps”) and many of these devices include multiple processors to process tasks that are associated with apps. In many instances, multiple processors are integrated as a collection of processor cores within a single functional subsystem. It is known that the processing load on a mobile device may be apportioned to the multiple cores, and that a cluster has two or more processors sharing execution resources such as a cache and a clock.

Threads form the basic block of execution for applications. An application may create one or more threads to execute its program logic. In some cases, two or more threads may be related to each other. Threads are related to each other if they work on some shared data. For example, one thread may process some portion of the data and pass on the data for further processing to another thread.

### SUMMARY

This disclosure relates to co-locating related threads for execution in the same cluster of a plurality of clusters. Methods, systems, and techniques for scheduling a plurality of threads for execution on a cluster of a plurality of clusters are provided.

According to an aspect, a method of scheduling a plurality of threads for execution on a cluster of a plurality of clusters includes determining that a first thread is dependent on a second thread. The first and second threads process a workload for a common frame. The method also includes selecting a cluster of a plurality of clusters. The method further includes scheduling the first and second threads for execution on the cluster.

According to another aspect, a system for scheduling a plurality of threads for execution on a cluster of a plurality of clusters includes a scheduler that determines that a first thread is related to a second thread, selects a cluster of a plurality of clusters, and schedules the first and second threads for execution on the cluster. The first and second threads process a workload for a common frame.

According to yet another aspect, a non-transitory processor-readable medium has stored thereon processor-executable instructions for performing operations including: determining that a first thread is dependent on a second thread, where the first and second threads process a workload for a common frame; selecting a cluster of a plurality of clusters; and scheduling the first and second threads for execution on the cluster.

### BRIEF DESCRIPTION OF THE DRAWINGS

The accompanying drawings, which form a part of the specification, illustrate embodiments of the invention and together with the description, further serve to explain the principles of the embodiments. In the drawings, like reference numbers may indicate identical or functionally similar elements. The drawing in which an element first appears is generally indicated by the left-most digit in the corresponding reference number.

FIG. 1 is a block diagram illustrating a system for scheduling a plurality of threads for execution on a cluster of a plurality of clusters in accordance with one or more embodiments.

FIG. 2 is a flowchart illustrating a method of scheduling a plurality of threads for execution on a cluster of a plurality of clusters in accordance with one or more embodiments.

FIG. 3 is a block diagram of an example computer system suitable for implementing any of the embodiments disclosed herein.

### DETAILED DESCRIPTION

### I. Overview

It is to be understood that the following disclosure provides many different embodiments, or examples, for implementing different features of the present disclosure. Some embodiments may be practiced without some or all of these specific details. Specific examples of components, modules, and arrangements are described below to simplify the present disclosure. These are, of course, merely examples and are not intended to be limiting.

Execution of related threads in a multi-cluster system poses several challenges. Two such challenges include the data sharing overhead between the related threads and the CPU frequency scaling ramp-up latency for the related threads when they happen to run in lockstep (one after the other). For example, related threads may be split to execute on different processors and different clusters. Each thread may perform one or more tasks. Data updated by a thread will normally be present in a processor cache, but is not shared across clusters. Data sharing efficiency may be affected because an updated copy of some data required by a thread running in one cluster may be present in another cluster. The overhead of inter-cluster communication to fetch and synchronize data in clusters may affect the data access latency experienced by threads, which directly affects their performance.

Moving execution of such related threads to occur in the same cluster may greatly improve data access latency, and hence, their performance. In addition, if the first of the related thread runs on a CPU with a lower CPU frequency, it will encounter a CPU frequency ramp-up latency such as when its CPU demand increases. In some embodiments, the CPU frequency scaling governor in an operating system kernel is responsible to scale the CPU frequency based on the task demand on a CPU core within a cluster. This CPU frequency is shared among all the cores in a given cluster. Now when the first related thread wakes-up the second related thread, the second related thread will not encounter the CPU frequency ramp-up latency because it is still running in the same cluster as the first related thread, and hence, has a greater chance to complete its work faster within a required timeline.

Furthermore, in a BIG.LITTLE type of computing architecture, an IPC (instruction per cycle) difference between a big cluster and a little cluster may exist. If one of the dependent threads is scheduled to execute on a big core (in the big cluster) and other thread is scheduled to execute on a little core (in the little cluster), the related threads together may not be able to complete the combined workload in a required timeline. This is because there is a difference in cluster capacity (the big cluster has a higher IPC than the little cluster), and in addition, both the clusters may be running at a different CPU frequency based on the workload that is currently running on the cluster. As a result, when two (or more) related threads are co-located to run within the same cluster, they have a better chance of completing the common workload within a given time window, and hence, provide better performance. For example, some user interfaces refresh at 60 Hertz (Hz), which requires the frame workload to be completed within 16.66 ms on the processor to maintain 60 frames per second (FPS) on the display.

In some embodiments, a method of scheduling a plurality of threads for execution on a cluster of a plurality of clusters includes determining that a first thread is dependent on a second thread. The first and second threads process a workload for a common frame (e.g., a user interface animation frame which needs to be updated at 60 fps on the display panel) and may (or may not be) be in a common process. In some embodiments, there may be more than two dependent threads processing a common workload concurrently or in lock step (one after the other). The method also includes selecting a cluster of a plurality of clusters. The method further includes scheduling the first and second threads for execution on the cluster.

Unless specifically stated otherwise, as apparent from the following discussion, it is appreciated that throughout the description, discussions utilizing terms such as “determining,” “generating,” “sending,” “receiving,” “executing,” “selecting,” “scheduling,” “aggregating,” “transmitting,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### II. Example System Architecture

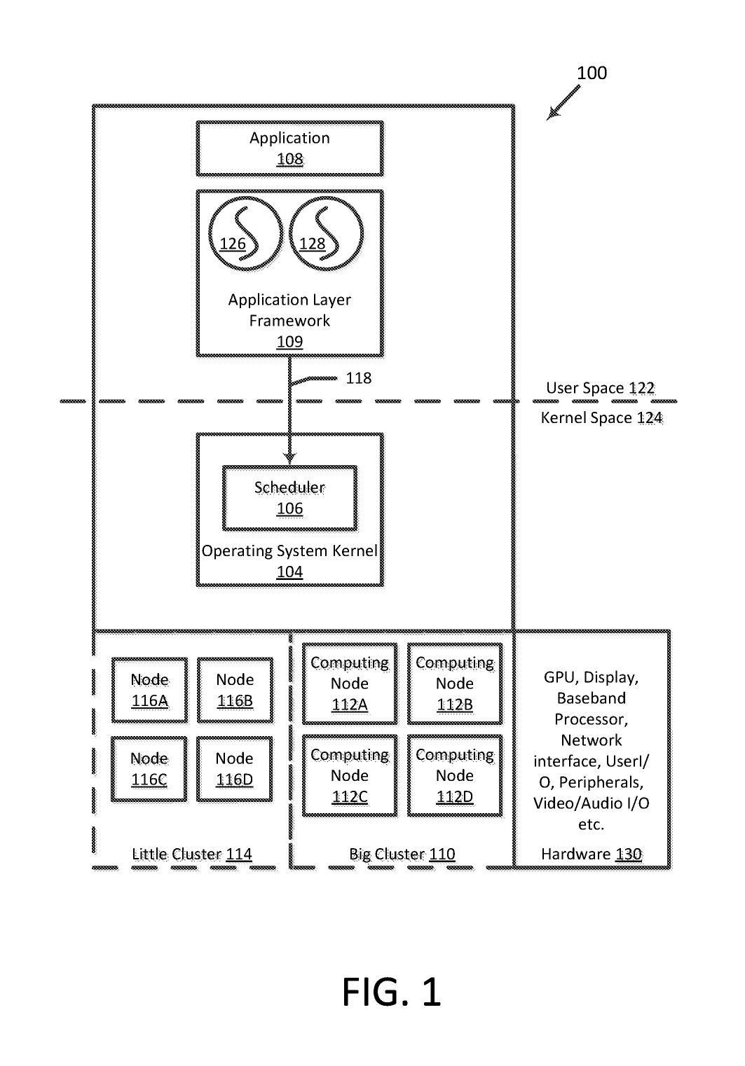

FIG. 1 is a block diagram illustrating a computing device 100 for scheduling a plurality of threads for execution on a cluster from among a plurality of clusters in accordance with one or more embodiments. The computing device 100 includes an operating system (OS) kernel 104, application 108, and an application layer framework 109. Computing device 100 also includes hardware 130 that may include, but is not limited to, a GPU, a display, a baseband processor, a network interface, user and I/O, peripherals, video/audio I/O, etc.

As shown, the computing device 100 includes a plurality of clusters including clusters 110 and 114. Cluster 110 (also referred to herein as a first cluster) includes one or more computing nodes 112A-112D, and cluster 114 (also referred to herein as a second cluster) includes one or more computing nodes 116A-116D. Each of the computing nodes may be a processor. In some examples, computing nodes 112A-112D of cluster 110 are a first set of processors, and computing nodes 116A-116D of cluster 114 is a second set of processors. In some examples, each computing node in a given cluster shares an execution resource with other computing nodes in the given cluster, but not with the computing nodes in another cluster. In an example, the execution resource is a cache memory and a CPU clock.

A “processor” may also be referred to as a “hardware processor,” “physical processor,” “processor core,” or “central processing unit (CPU)” herein. A processor refers to a device capable of executing instructions encoding arithmetic, logical, or input/output (I/O) operations. In one illustrative example, a processor may follow the Von Neumann architectural model and may include an arithmetic logic unit (ALU), a control unit, and a plurality of registers. In a further aspect, a processor may be a single core processor that is typically capable of executing one instruction at a time (or process a single pipeline of instructions), or a multi-core processor that may simultaneously execute multiple instructions. In another aspect, a processor may be implemented as a single integrated circuit, two or more integrated circuits, or may be a component of a multi-chip module (e.g., in which individual microprocessor dies are included in a single integrated circuit package and hence share a single socket).

The clusters 110 and 114 in this embodiment may be implemented in accord with a BIG.LITTLE type of computing architecture. The BIG.LITTLE type of computing architecture is a heterogeneous computing architecture that couples relatively battery-saving and slower processor cores (little) with relatively more powerful and power-hungry ones (big). Typically, only one “side” or the other will be active at once, but because all the cores have access to the same memory regions, workloads can be swapped between big and little cores on the fly. The intention is to create a multi-core processor that can adjust better to dynamic computing needs and use less power than clock scaling alone.

In the embodiment depicted in FIG. 1, the cluster 110 may be a big cluster, and the cluster 114 may be a little cluster. Thus, computing nodes 112A-112D in cluster 110 may be faster than computing nodes 116A-116D in cluster 114. For example, computing nodes 112A-112D may execute more instructions per second than computing nodes 116A-116D.

Computing device 100 may execute application 108, which uses resources of computing device 100. The application 108 may be realized by any of a variety of different types of applications (also referred to as apps) such as entertainment and utility applications. Although one application 108 is illustrated in FIG. 1, it should be understood that computing device 100 may execute more than one application. OS kernel 104 may serve as an intermediary between hardware 130 and software (e.g., application 108). OS kernel 104 may be viewed as a comprehensive library of functions that can be invoked by the application 108. A system call is an interface between the application 108 and library of the OS kernel 104. By invoking a system call, the application 108 can request a service that the OS kernel 104 then fulfills. For example, in networking, an application may send data though the OS kernel 104 for transmission over a network (e.g., via NIC 136).

A system memory of computing device 100 may be divided into two distinct regions: a user space 122 and a kernel space 124. The application 108 and application layer framework 109 may execute in user space 122, which includes a set of memory locations in which user processes run. A process is an executing instance of a program. The OS kernel 104 may execute in kernel space 124, which includes a set of memory locations in which OS kernel 104 executes and provides its services. The kernel space 124 resides in a different portion of the virtual address space from the user space 122.

Although two clusters are illustrated in FIG. 1, other embodiments including more than two clusters are within the scope of the present disclosure. The clusters 110, 114 may reside within the hardware 130 as part of a same device (e.g., smartphone) as the computing device 100. Or the clusters 110, 114 may be coupled to the computing device 100 via a network. For example, the network may include various configurations and use various protocols including the Internet, World Wide Web, intranets, virtual private networks, wide area networks, local networks, private networks using communication protocols proprietary to one or more companies, cellular and other wireless networks, Internet relay chat channels (IRC), instant messaging, simple mail transfer protocols (SMTP), Ethernet, WiFi and HTTP, and various combinations of the foregoing.

The application 108 may execute in computing device 100. The application 108 is generally representative of any application that provides a user interface (UI) (e.g., GMAIL or FACEBOOK) on a display (e.g., touchscreen display) of the computing device 100. A process may include several threads that all share the same data and resources but take different paths through the program code. When application 108 starts running in computing device 100, the OS kernel 104 may start a new process for application 108 with a single thread of execution and assign the new process its own address space. The single thread of execution may be referred to as the “main” thread or the “user interface (UI)” thread.

In the example illustrated in FIG. 1, the computing device 100 may create a first thread 126 and a second thread 128 in the same process for application 108. The first thread 126 may spawn the second thread 128 and identify itself as the second thread 128′s parent thread. In some examples, the first thread 126 is a UI thread that performs general UI-related work and records all the OpenGL application programming interface (API) calls, and second thread 128 is a renderer thread that executes all of the OpenGL calls to the GPU. The first thread 126 may send a stream of commands to the second thread 128, which causes the GPU to render image data stored in a frame buffer to a display device (e.g., a touch screen display). When the UI thread is ready to submit its work to a GPU, the UI thread may send a signal to the renderer thread to wake up. The renderer thread may receive the signal, wake up, and process the user-interface animation workload on the GPU. The work performed by the first thread 126 and the second thread 128 may be executed in one of the clusters 110, 114, as will be discussed further below. Although FIG. 1 depicts only two threads (the first thread 126 and the second thread 128) for clarity, it should be recognized that the first thread 126 and the second thread 128 generally represent a set of dependent threads (two or more threads), wherein the dependent threads each process a part of the common workload and may be in a common operating system (OS) process or different OS processes.

Application layer framework 109 may be a generic framework that runs in the context of threads of the application 108. The application layer framework 109 may be aware of the dependencies of the threads in the framework. Application layer framework 109 may identify related threads and mark them as related. In some embodiments, computing device 100 executes the ANDROID OS, application 108 is a UI application (e.g., GMAIL or FACEBOOK running on a touchscreen display), and application layer framework 109 is an ANDROID framework layer (e.g., a hardware user interface framework layer (HWUI)) that is responsible for using hardware (e.g., a GPU) to accelerate the underlying frame drawing. By default, HWUI applications have threads of execution that are in lockstep with each other.

In some embodiments, the application layer framework 109 knows that a predetermined number of threads are related and the application layer framework 109 is aware of the type of each thread. In an example, the predetermined number of threads is two, and the threads are of a first type (e.g., UI thread) and a second type (e.g., renderer thread). In this example, application layer framework 109 may mark first thread 126 as the UI thread and second thread 128 as the renderer thread and mark them as related. Application layer framework 109 may mark two threads as related by providing them with a common thread identifier via the dependent task identifier system call 118. In some examples, application layer framework 109 marks each of first thread 126 and second thread 128 once, and these marks may stay with the threads throughout the duration of the running process.

The first and second threads 126, 128 may share data, and thus, be related. The first thread 126 and the second thread 128 may process data for a workload for each rendered frame. The first thread 126 may be a UI thread that produces data that is consumed by second the thread 128. In this example, second thread 128 may be a renderer thread that is called by and dependent on the UI thread. Each application running on computing device 100 may have its own UI thread and renderer thread.

In some examples, application 108 may produce a workload that is expected to be finished in accordance with a timeline. In an example, application 108 is expected to render 60 frames per second (FPS) of a user-interface animation onto a display. In this example, within one second, 60 frames are rendered on the display. For each frame, the same first thread 126 and second thread 128 may process a workload for the frame in lockstep (one after the other). The first thread 126 finished its portion of the workload processing and wakes up the second thread 128 to continue its porting of workload processing. If the second thread 128 takes longer to complete its workload processing; the first thread 126 may start working on the next frame and at times be working in parallel with the second thread 128 taking advantage of the multicore CPU processor.

As shown in FIG. 1, the OS kernel 104 includes a scheduler 106 that schedules threads for execution on a plurality of clusters (e.g., cluster 110 and/or cluster 114). In operation, the scheduler 106 receives threads from the application layer framework 109 and may determine on which cluster of the plurality of clusters to schedule the threads for execution. In an example, scheduler 106 receives the first thread 126 and the second thread 128 and determines, based on their markings, that they are related. Scheduler 106 may identify dependencies of the threads. For example, scheduler 106 may recognize that first thread 126 calls and passes data to second thread 128.

In some embodiments, the scheduler 106 maintains the list of related groups and the threads in each of them. In some embodiments, the scheduler 106 selects a cluster of the plurality of clusters and schedules first thread 126 and second thread 128 for execution on the selected cluster. The scheduler 106 sends the first thread 126 and the second thread 128 to distinct computing nodes of the selected cluster for execution. The scheduler 106 may select a single cluster of the plurality of clusters such that the related threads are executed on the same cluster

In some examples, the scheduler 106 selects cluster 110 (also referred to herein as a first cluster) for the thread execution. The scheduler 106 may send a request to NIC 136 to transmit first thread 126 and second thread 128 and its associated data to cluster 110. One or more of computing nodes 112A-112D may receive the first thread 126 and second thread 128 and execute the threads. The computing nodes (also referred to as a plurality of processors) of cluster 110 share an execution resource such as a cache memory. When the second thread 128 consumes data produced by the first thread 126, it may be unnecessary for the data to be fetched from a cache that is external to the caches in the cluster 110. Rather, the second thread 128 may quickly fetch the data from computing node 112A′s cache without reaching across the network. Cluster 110 may process first thread 126 and second thread 128 and send a result of the processed threads back to computing device 100. Computing device 100 may display the result to the user.

In some embodiments, an aggregate demand for a group of related threads is derived by summing up processor demand of member threads. The aggregate demand may be used to select a preferred cluster in which member threads of the group are to be run. When member threads become eligible to run, they are placed (if feasible) to run in a processor belonging to the preferred cluster. If all the processors in a preferred cluster are too busy serving other threads, scheduler 106 may schedule the threads for execution on another cluster, breaking their affinity towards the preferred cluster. Such threads may be migrated toward their preferred cluster at a future time when the processors in the preferred cluster become available to service more tasks.

In some examples, computing nodes 112A-112D (also referred to herein as a plurality of processors) in cluster 110 are faster (big cluster) than computing nodes 116A-116D (also referred to herein as processors) in cluster 114 (little cluster). For example, computing nodes 112A-112D execute more instructions per second than computing nodes 116A-116D. The scheduler 106 may aggregate a processor demand of the first thread 126 and a processor demand of the second thread 128 and determine whether the aggregated processor demand satisfies a predefined threshold. For example, the scheduler 106 may select, based on whether the aggregated CPU demand satisfies the threshold, a cluster on which first thread 126 and second thread 128 may execute. Scheduler 106 may select cluster 114 (little cluster) if the aggregated CPU demand is below the predefined threshold and selects cluster 110 (big cluster) if the aggregated CPU demand is at or above the predefined threshold.

As discussed above and further emphasized here, FIG. 1 is merely an example, which should not unduly limit the scope of the claims. For example, although two related threads are shown, it should be understood that more than two threads may be related and sent to scheduler 106 for scheduling.

### III. Example Method

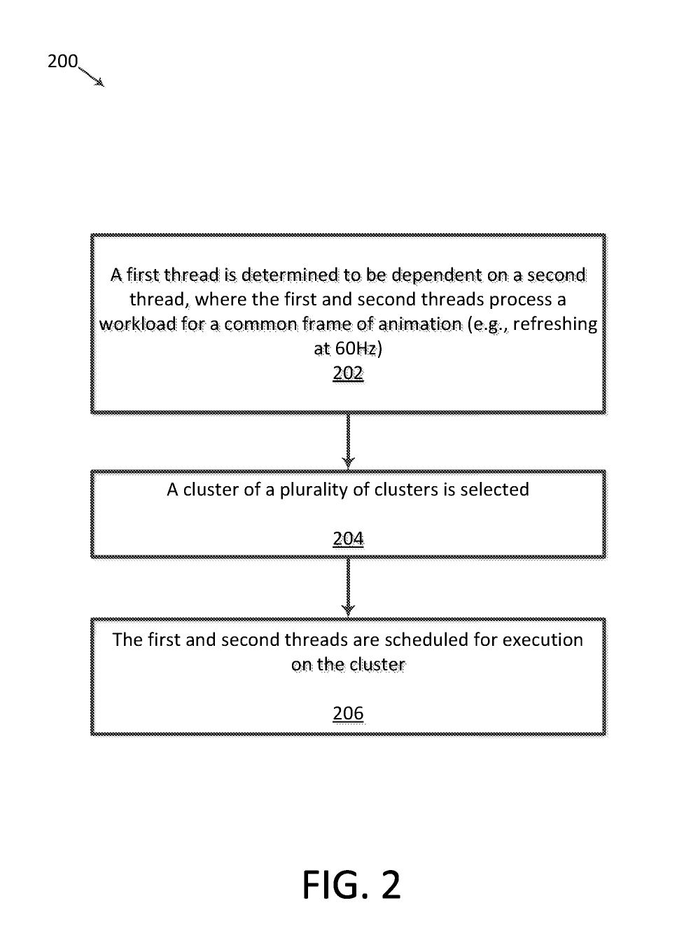

FIG. 2 is a flowchart illustrating a method 200 of scheduling a plurality of threads for execution on a cluster of a plurality of clusters in accordance with one or more embodiments. Method 200 is not meant to be limiting and may be used in other applications.

Method 200 includes blocks 202-206. As shown, in connection with the execution of an application (e.g., application 108), a user-interface animation workload of a common frame is split into a plurality of distinct portions, and a first and second threads are generated. And in block 202, the first thread is determined to be dependent on the second thread, where the first and second threads process a workload for a common frame of animation (e.g., refreshing at 60 Hz) and may (or may not be) in a common process. In an example, the OS kernel 104 determines that second thread 128 is dependent on first thread 126, where first thread 126 and second thread 128 process a workload for a common frame and may (or may not be) in a common process. In a block 204, a cluster from among a plurality of heterogeneous clusters is selected. For example, the big cluster 110 and little cluster 114 are heterogeneous clusters. In an example, the OS kernel 104 selects cluster 110 of a plurality of clusters. In a block 206, the first and second threads are scheduled for collocated execution on the selected cluster to complete a processing of the user-interface animation workload in a required time window. In an example, the OS kernel 104 schedules first thread 126 and second thread 128 for execution on cluster 110.

It is understood that additional processes may be inserted before, during, or after blocks 201-206 discussed above. It is also understood that one or more of the blocks of method 200 described herein may be omitted, combined, or performed in a different sequence as desired. Moreover, the method depicted in FIG. 2 is generally applicable to scheduling two or more threads—it is certainly not limited to scheduling two threads. In some embodiments, one or more actions illustrated in blocks 201-206 may be performed for any number of related threads received by scheduler 106 for execution on a cluster.

### IV. Example Computer System

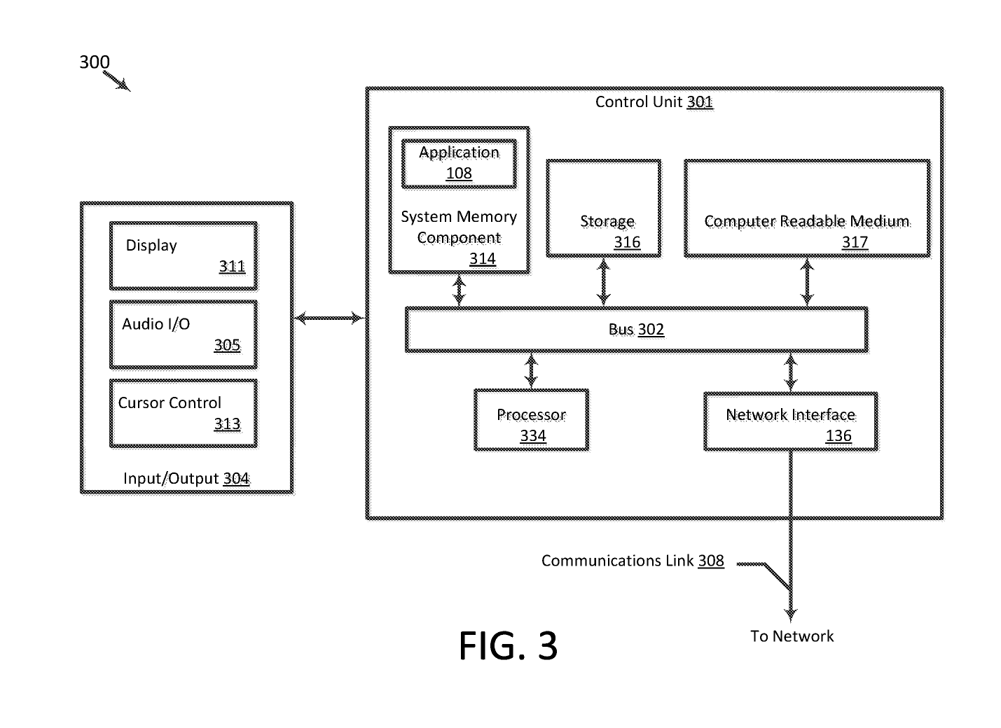

FIG. 3 is a block diagram of an example computer system 300 suitable for implementing any of the embodiments disclosed herein. Computer system 300 may be, but is not limited to, a mobile device (e.g., smartphone, tablet, personal digital assistant (PDA), or laptop, etc.), stationary device (e.g., personal computer, workstation, etc.), game console, set-top box, kiosk, embedded system, or other device having at least one processor and memory. In various implementations, computer system 300 may be a user device.

Computer system 300 includes a control unit 301 coupled to an input/output (I/O) 304 component. Control unit 301 may include one or more processors 334 and may additionally include one or more storage devices each selected from a group including floppy disk, flexible disk, hard disk, magnetic tape, any other magnetic medium, CD-ROM, any other optical medium, random access memory (RAM), programmable read-only memory (PROM), erasable ROM (EPROM), FLASH-EPROM, any other memory chip or cartridge, and/or any other medium from which a processor or computer is adapted to read. The one or more storage devices may include stored information that may be made available to one or more computing devices and/or computer programs (e.g., clients) coupled to computer system 300 using a computer network (not shown). The computer network may be any type of network including a LAN, a WAN, an intranet, the Internet, a cloud, and/or any combination of networks thereof that is capable of interconnecting computing devices and/or computer programs in the system. In some examples, the stored information may be made available to cluster 110 or cluster 114.

As shown, the computer system 300 includes a bus 302 or other communication mechanism for communicating information data, signals, and information between various components of computer system 300. Components include I/O component 304 for processing user actions, such as selecting keys from a keypad/keyboard or selecting one or more buttons or links, etc., and sends a corresponding signal to bus 302. I/O component 304 may also include an output component such as a display 311, and an input control such as a cursor control 313 (such as a keyboard, keypad, mouse, etc.). An audio I/O component 305 may also be included to allow a user to use voice for inputting information by converting audio signals into information signals. Audio I/O component 305 may allow the user to hear audio. In some examples, a user may select application 108 and open it on computing device 100. Response to the user's selection, OS kernel 104 may start a new process for application 108 with a single thread of execution and assign the new process its own address space. The single thread of execution may be first thread 126, which may then call into second thread 128.

A transceiver or NIC 136 transmits and receives signals between computer system 300 and other devices via a communications link 308 to a network. In some embodiments, the transmission is wireless, although other transmission mediums and methods may also be suitable. In an example, NIC 136 sends first thread 126 and second thread 128 over the network to cluster 110. Additionally, display 311 may be coupled to control unit 301 via communications link 308. Cluster 110 may process first thread 126 and second thread 128 and send the result back to computer system 300 for display on display 311.

The processor 334 in this embodiment is a multicore processor in which the clusters 110, 114 described with reference to FIG. 1 may reside. Components of computer system 300 also include a system memory component 314 (e.g., RAM), a static storage component 316 (e.g., ROM), and/or a computer readable medium 317. Computer system 300 performs specific operations by processor 334 and other components by executing one or more sequences of instructions contained in system memory component 314. Logic may be encoded in processor readable medium 317, which may refer to any medium that participates in providing instructions to processor 334 for execution. Such a medium may include non-volatile media (e.g., optical, or magnetic disks, or solid-state drives) and volatile media (e.g., dynamic memory, such as system memory component 314).

In some embodiments, the logic is encoded in non-transitory processor readable medium. Processor readable medium 317 may be any apparatus that can contain, store, communicate, propagate, or transport instructions that are used by or in connection with processor 334. Processor readable medium 317 may be an electronic, magnetic, optical, electromagnetic, infrared, or semiconductor device or any other memory chip or cartridge, or any other medium from which a computer is adapted to read.

In various embodiments of the present disclosure, execution of instruction sequences (e.g., method 200) to practice the present disclosure may be performed by computer system 300. In various other embodiments of the present disclosure, a plurality of computer systems 300 coupled by communications link 308 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also where applicable, the various hardware components and/or software components set forth herein may be combined into composite components including software, hardware, and/or both without departing from the spirit of the present disclosure. Where applicable, the various hardware components and/or software components set forth herein may be separated into sub-components including software, hardware, or both without departing from the spirit of the present disclosure. In addition, where applicable, it is contemplated that software components may be implemented as hardware components, and vice-versa.

Application software in accordance with the present disclosure may be stored on one or more processor readable mediums. It is also contemplated that the application software identified herein may be implemented using one or more general purpose or specific purpose computers and/or computer systems, networked and/or otherwise. Where applicable, the ordering of various blocks described herein may be changed, combined into composite blocks, and/or separated into sub-blocks to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Changes may be made in form and detail without departing from the scope of the present disclosure. Thus, the present disclosure is limited only by the claims.

What is claimed is:

1. A method of scheduling a plurality of threads for execution on a cluster of a plurality of clusters, comprising:
splitting a user-interface animation workload of a common frame into a plurality of distinct portions;
determining that a first thread is dependent on a second thread, wherein each of the first and second threads process a corresponding one of the plurality of distinct portions;
selecting a cluster from among a plurality of heterogeneous clusters; and
scheduling the first and second threads for collocated execution on the selected cluster to complete a processing of the user-interface animation workload in a required time window.

2. The method of claim 1, comprising:
sending the first and second threads to one or more computing nodes of the selected cluster for execution.

3. The method of claim 1, wherein the first and second threads share data.

4. The method of claim 3, wherein the first thread produces data that is consumed by the second thread.

5. The method in claim 3, wherein the processing of the user-interface animation workload is complete when the first and second threads complete processing of a respective portion of the user-interface animation workload.

6. The method of claim 1, wherein the plurality of clusters includes a first cluster including a first set of processors and a second cluster including a second set of processors, and wherein the first set of processors execute more instructions per second than the second set of processors.

7. The method of claim 6, comprising:
aggregating a processor demand of the first thread and a processor demand of the second thread, wherein the selecting includes selecting the first cluster if the aggregated processors demand satisfies a threshold and selecting the second cluster if the aggregated processors demand does not satisfy the threshold.

8. The method of claim 1, wherein the first thread is a user interface (UI) thread and the second thread is a renderer thread, and the first thread produces data that is consumed by the second thread.

9. A computing device, comprising:
an application configured to generate a user-interface animation workload;
a plurality of heterogeneous clusters, each of the plurality of heterogeneous clusters includes a plurality of processors;
a scheduler configured to:
determine that a first thread is related to a second thread, wherein each of the first and second threads process a corresponding one of a plurality of distinct portions for a common frame of the user-interface animation workload;
select a cluster from among the plurality of clusters; and
schedule the first and second threads for co-located execution on the selected cluster to complete a processing of the common frame in a required time window.

10. The computing device of claim 9, comprising:
an application layer framework configured to mark the first and second threads as related threads.

11. The computing device of claim 9, wherein the plurality of clusters includes a first cluster and a second cluster, and the first cluster includes a first set of processors and the second cluster includes a second set of processors.

12. The computing device of claim 11, wherein the first set of processors execute more instructions per second than the second set of processors.

13. The computing device of claim 12, wherein each of the first set of processors share an execution resource with each other processor in the first set of processors, but not with the second set of processors.

14. The computing device of claim 13, wherein the execution resource is a cache.

15. The computing device of claim 9, wherein the first and second threads share data.

16. The computing device of claim 15, wherein the first thread is a user interface (UI) thread and the second thread is a renderer thread, and the first thread produces data that is consumed by the second thread.

17. The computing device of claim 16, wherein the first thread records OpenGL application programming interface (API) calls.

18. The computing device of claim 17, wherein the second thread executes the OpenGL calls to a graphics processing unit GPU.

19. A non-transitory processor-readable medium having stored thereon processor-executable instructions for performing operations, comprising:
splitting a user-interface animation workload of a common frame into a plurality of distinct portions;
determining that a first thread is dependent on a second thread, wherein each of the first and second threads process a corresponding one of the plurality of distinct portions;
selecting a cluster from among a plurality of heterogeneous clusters; and
scheduling the first and second threads for collocated execution on the selected cluster to complete a processing of the user-interface animation workload in a required time window.

20. The non-transitory processor-readable medium of claim 19, wherein the processor-executable instructions for performing operations further comprise:
sending the first and second threads to one or more computing nodes of the cluster for execution.
